(19) United States
(12) Patent Application Publication
(10) Pub. No.: US 2010/0145562 A1
(43) Pub. Date: Jun. 10, 2010

(54) Method of Controlling Engine Stop-Start Operation for Heavy-Duty Hybrid-Electric Vehicles

(75) Inventor: Brian D. Moran, La Mesa, CA (US)

Correspondence Address: PROCOPIO, CORY, HARGREAVES & SAVITCH LLP, 530 B STREET, SUITE 2100, SAN DIEGO, CA, 92101, US

(73) Assignee: ISE CORPORATION, Poway, CA (US)

(21) Appl. No.: 12/706,111

(22) Filed: Feb. 16, 2010

Related U.S. Application Data
(63) Continuation-in-part of application No. 12/057,281, filed on Mar. 27, 2008, now Pat. No. 7,680,568.
Application No. 12/057,281 is a division of application No. 11/390,605, filed on Mar. 28, 2006, now Pat. No. 7,689,331.
Application No. 11/390,605 is a continuation-in-part of application No. 11/289,069, filed on Nov. 29, 2005, now Pat. No. 7,689,330.
(60) Provisional application No. 60/632,046, filed on Dec. 1, 2004.

(51) Int. Cl. G06F 19/00

(52) U.S. Cl. 701/22; 180/65.28

(57) ABSTRACT

A start-stop or idle-stop method for a heavy-duty hybrid vehicle that turns off the fuel supply while maintaining the crankshaft rotation of the internal combustion engine when the vehicle stops or, optionally, when the vehicle travels downhill, travels in a noise sensitive location, travels in an exhaust emissions sensitive location, or operates in an emergency situation. The stop-start or idle-stop method automatically turns on the engine fuel supply to restart combustion when the vehicle starts accelerating, is no longer traveling downhill, is no longer traveling in a noise sensitive or exhaust sensitive location, is no longer in an emergency situation, or has dropped below the minimum energy storage restart level. The stop-start or idle-stop may be inhibited upon certain override conditions.

### CROSS-REFERENCE TO RELATED APPLICATIONS

This application is a continuation in part of U.S. patent application Ser. No. 12/057,281 filed Mar. 27, 2008, which is a divisional of U.S. patent application Ser. No. 11/390,605 filed Mar. 28, 2006, which is a continuation in part of U.S. patent application Ser. No. 11/289,069 filed Nov. 29, 2005, and claims the benefit of U.S. Provisional Application No. 60/632,046 filed Dec. 1, 2004 under 35 U.S.C. 119(e). All of the above applications are incorporated by reference as though set forth in full.

### FIELD OF THE INVENTION

The field of the invention relates to the stop-start operation of a hybrid-electric or hybrid-hydraulic heavy-duty vehicle with a gross vehicle weight rating of 10,000 lbs or higher.

### BACKGROUND OF THE INVENTION

In typical heavy-duty vehicle applications, including those with hybrid drive systems, a rotating internal combustion engine includes multiple gear and/or pulley and belt power take-offs (PTOs) that operate the vehicle subsystems and accessories. As a result, turning off the engine causes the vehicle subsystems and accessories to be turned off.

It is desirable to eliminate engine idling at vehicle stops to, among other things, increase fuel economy, minimize noise, and minimize engine exhaust emissions pollution to improve the quality of the operating environment. This is especially true for transportation and delivery vehicles such as, but not limited to, urban transit buses and local package freight pick up and delivery vans that may experience hundreds of stops during daily operation.

A driver could manually turn off and turn on an engine when stopped; however, in addition to the problem of the vehicle subsystems and accessories not operating, a typical electric starter motor for the internal combustion engine would wear out rather quickly because it is typically not designed for the hundreds of stop-starts per day of transportation and delivery vehicles. Furthermore, stopping and restarting the engine rotation and associated PTO engine coolant and lubrication pumps could have an effect on engine wear and durability.

### SUMMARY OF THE INVENTION

An aspect of the present disclosure involves a method for controlling the automatic shut down or engine turn-off during vehicle stops or downhill coasting and the automatic engine restart during vehicle acceleration. Engine shut down or turn-off and automatic restart may involve only turning the fuel supply off and on while maintaining the engine rotation by using the generator/motor and energy storage of a hybrid drive vehicle, or an integrated starter-alternator with the energy storage of a standard drive vehicle. Turning off the fuel supply while maintaining engine rotation during vehicle stops or extended downhill travel stops the combustion and exhaust emissions, minimizes engine noise, while maintaining the operation of PTO accessories.

During downhill travel the generator/motor can continue to spin the engine with the fuel supply cut off by using the energy available from the braking regeneration operating mode of the electric traction propulsion motors of a hybrid-electric vehicle (HEV).

In another aspect of the disclosure, a hybrid-electric vehicle has all or part of the vehicle propulsion power supplied by an electric motor and has an on board electric energy storage to assist the primary power unit during vehicle acceleration power requirements. The energy storage unit can be charged from available excess primary power and/or braking regeneration energy supplied from the electric motor/generator during electromagnetic braking deceleration. In this disclosure the energy storage unit also supplies power to operate vehicle accessory subsystems such as the heating, ventilation, and air conditioning (HVAC) system, hydraulic system for steering and equipment actuators, compressed air system for brakes and air bag suspensions, and various 12 volt and 24 volt standard accessories. The energy storage unit may also supply power to spin an internal combustion engine by means of the electric power generator operating as a motor that is mechanically coupled to an engine. Such spinning can be used to start the engine or maintain engine rotation during fuel cut off.

The major hybrid-electric drive components are an internal combustion engine mechanically coupled to an electric power generator, an energy storage device such as a battery or an ultracapacitor pack, and an electrically powered traction motor mechanically coupled to the vehicle propulsion system. The vehicle has accessories that can be powered from the energy storage and vehicle operation does not require that the engine be running for stopping, standing, coasting, or startup acceleration. Alternatively, vehicle accessories may be mounted as engine PTO's that can be powered by spinning the engine by means of the mechanically coupled electric power generator/motor with electrical power supplied by the energy storage. This aspect of the present disclosure applies to a heavy-duty vehicle with an engine mechanically connected to a generator, an energy storage subsystem, and an electric traction motor for vehicle propulsion. The electric generator/motor, energy storage, and traction motor/generator are all electrically connected to a high voltage power distribution network.

For a series hybrid-electric configuration the engine is only connected to the generator and not mechanically connected to the vehicle wheel propulsion.

For a parallel hybrid-electric configuration the engine and the electric traction motor are both mechanically connected to the vehicle wheel propulsion. Furthermore, the parallel configuration has an electric traction motor than can also act as a generator and includes the capability to mechanically decouple the engine-generator combination from the vehicle wheel propulsion; or the parallel configuration has the capability to mechanically decouple the engine from the electric motor traction propulsion and include a separate generator-starter that is mechanically coupled to the engine and can be used to charge the energy storage system and start the engine hundreds of times per day. Alternatively, with power supplied from the energy storage or braking regeneration of the traction motor/generator the generator-starter can be used to spin the engine with the fuel supply turned off, thereby, powering the PTO accessories mechanically attached to the engine crankshaft rotation.

In a further aspect of the disclosure, a hybrid-hydraulic vehicle has all or part of the vehicle propulsion power supplied by a hydraulic motor and has an on board hydraulic accumulator energy storage to assist the primary power unit during vehicle acceleration power requirements. The energy storage unit can be charged from available excess primary power and/or braking regeneration energy supplied from the hydraulic motor/pump during hydraulic braking deceleration. In this aspect the energy storage unit also supplies power to operate hydraulically powered or hydraulic-electrically powered vehicle accessory subsystems such as, but not limited to, the heating, ventilation, and air conditioning (HVAC) system, hydraulic system for steering and equipment actuators, compressed air system for brakes and air bag suspensions, and various 12 volt and 24 volt standard accessories. The energy storage unit may also supply power to spin an internal combustion engine by means of hydraulic pump operating as a hydraulic motor that is mechanically coupled to an engine. Such spinning can be used to start the engine or maintain engine rotation during fuel cut off. This spinning can occur during a vehicle stop or during downhill travel similarly as described above for the hybrid-electric vehicle.

The major hybrid-hydraulic drive components are an internal combustion engine mechanically coupled to hydraulic pump, a hydraulic accumulator energy storage device, and a hydraulically powered traction motor mechanically coupled to the vehicle propulsion system. The vehicle has accessories that can be powered from the energy storage and vehicle operation does not require that the engine be running for stopping, standing, or startup acceleration. Alternatively, the hydraulic pump/motor can spin the engine with the fuel cut off to operate the PTO accessories. This aspect of the present disclosure applies to a heavy-duty vehicle with an engine mechanically connected to a hydraulic pump, an energy storage subsystem such as a hydraulic accumulator, and a hydraulic traction motor for vehicle propulsion. The pump, energy storage, and traction motor are all hydraulically connected to a high pressure power distribution network.

For a series hybrid-hydraulic configuration the engine is only connected to the hydraulic pump and not mechanically connected to the vehicle wheel propulsion.

For a parallel hybrid-hydraulic configuration the engine and the hydraulic traction motor are both mechanically connected to the vehicle wheel propulsion. Furthermore, the parallel configuration has a hydraulic traction motor than can also act as a hydraulic pump and includes the capability to mechanically decouple the engine-pump combination from the vehicle wheel propulsion; or the parallel configuration has the capability to mechanically decouple the engine from the hydraulic motor traction propulsion and includes a separate electric or hydraulic generator-starter that is mechanically coupled to the engine and can be used to charge the low voltage energy storage system and start the engine hundreds of times per day.

An aspect of the present invention involves a method for controlling an automatic shut down or engine turn-off in accordance with a Start-Stop or Idle-Stop algorithm. The Start-Stop or Idle-Stop, however, may be inhibited or disengaged upon the presence of one or more overriding conditions. The overriding conditions may include any aspect of the engine that takes priority over the benefits the engine being shut down. Preferably, the overriding conditions will include at least one of a maintenance status and a heat/temperature demand. In other embodiments, the method may consider a propulsion power requirement as well as the amount of stored propulsion energy. According to one embodiment, rather than shutting down the engine, the method may include spinning the engine without combustion.

### BRIEF DESCRIPTION OF THE DRAWINGS

The accompanying drawings, which are incorporated in and form a part of this specification, illustrate the logic flow of the invention and its embodiments, and together with the description, serve to explain the principles of this invention.

FIG. 1A is an block diagram of an embodiment of a series hybrid-electric drive system with electrically powered accessories.

FIG. 1B is a block diagram of an embodiment of a parallel hybrid-electric drive system with electrically powered accessories.

FIG. 2 is a flowchart of an exemplary stop-start control method.

FIG. 3 is a flowchart of an exemplary engine turn-on sequence.

FIG. 4 is a flow chart of an exemplary engine turnoff sequence

FIG. 5 is a flow chart of an exemplary engine turnoff sequence when the vehicle is traveling downhill.

FIG. 6 is a flow chart of an exemplary engine turnoff sequence when the vehicle is traveling propelled by stored energy only, e.g., silent operation.

FIG. 7 is a flow chart of an exemplary engine turnoff sequence when the vehicle is stopped and the generator continues to spin the engine crankshaft.

FIG. 8 is a block diagram illustrating an exemplary computer as may be used in connection with the systems to carry out the methods described herein.

FIG. 9 is a flow chart of an exemplary engine turnoff sequence that is inhibited upon certain override conditions.

FIG. 10 illustrates one example of shifting a heat available vs. heat required comparisons.

FIG. 11 is a simplified illustration of one embodiment of the method described in FIG. 9.

### DETAILED DESCRIPTION OF THE INVENTION

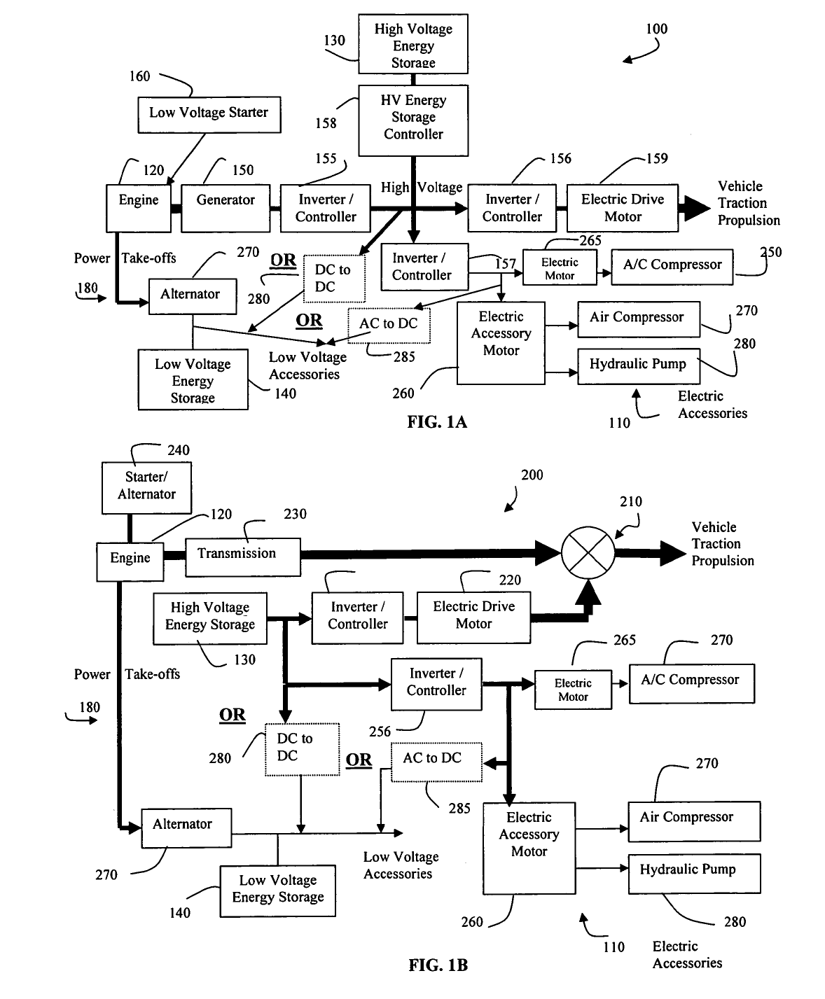

With reference to FIG. 1A, an embodiment of a series hybrid-electric drive system 100 with electrically powered accessories 110 will be described. An engine 120 can be turned off because both the high voltage requirements and the low voltage requirements are met by respective energy storages 130, 140. A generator 150 is operated as a motor to spin the engine 120 during frequent restarts. A low-voltage engine starter 160 may be used infrequently with the generator 160 whenever the high-voltage energy storage 130 can not deliver enough power to the generator 150 for spinning the engine 120 during engine start. For example, in an implementation of this embodiment where ultracapacitors are used for energy storage, the low voltage starter 160 is used at the beginning of the day when the ultracapacitors are empty. The engine 120 may be any internal combustion engine that would be used to produce enough power to provide traction for propelling the vehicle.

With reference to FIG. 1B, an embodiment of a parallel hybrid-electric drive system 200 with electrically powered accessories 110 will be described. Again, the engine 120 can be turned off because both the high voltage requirements and the low voltage requirements are met by the respective energy storages 130, 140. FIG. 1B conceptually depicts that the electric motor mechanical output and the engine mechanical output operate in parallel and are coupled together to add power and torque to the traction propulsion drive train 210. In a typical implementation, a motor 220 is located in front or behind a transmission 230 and turns the same mechanical torque shaft as the engine and transmission. In the Stop-Start method of the present invention, the engine 120 and the electric motor 220 must be able to decouple from the vehicle propulsion drive train 210 to allow the electric motor 220 to spin the engine 120 during engine startup. Turning off and restarting of the vehicle internal combustion engine does not cause engine damage and can be performed a multiplicity of times without causing degradation of the starting mechanism. Alternatively, in place of, or in addition to a standard low voltage starter, a separate generator/starter 240 capable of hundreds of restarts per day is provided for the engine 120.

As illustrated in FIGS. 1A and 1B, an air conditioning (A/C) compressor 250 is assumed to include its own electric motor drive 265 similar to the air conditioning units used in fixed buildings. In the embodiments shown, the hydraulic pump and air compressor units 270, 280 are driven by the single electric motor 260, but in an alternative embodiment, each may have its own electric motor. The low-voltage requirements are supplied by either a Power Take-Off (PTO) alternator or generator 270, a DC-to-DC converter 280 from the high voltage distribution bus, or an AC-to-DC power supply 285 from the AC inverter bus. The low-voltage energy storage 140 is also shown in the diagrams, but may be unnecessary if the DC-to-DC converter 280 were used and there was always sufficient energy available to start the engine 120.

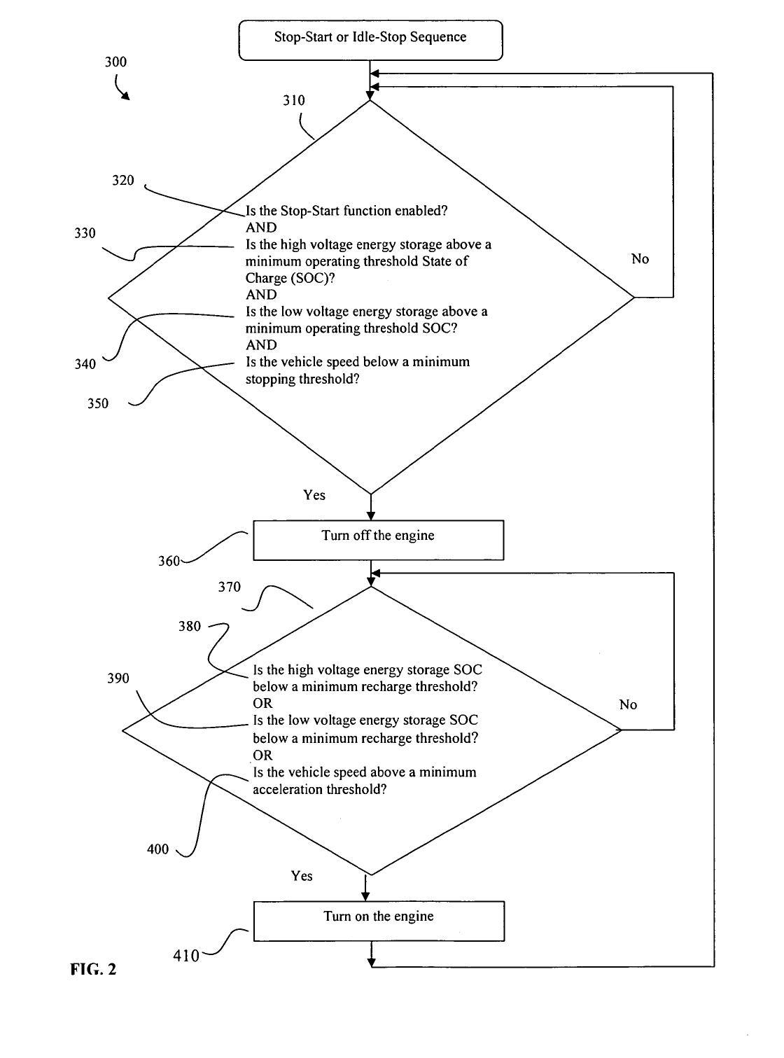

With reference additionally to FIG. 2, an exemplary Stop-Start or Idle-Stop method 300 will be described. The method is embodied in the programmed software of the vehicle drive system control computer, which has the physical and protocol interfaces with the vehicle control and various component computers that control and report subsystem status. The software controls operation of the engine, generator, energy storage, and the drive system computer controllers to safely and efficiently turn off the engine 120 when the vehicle stops and restart the engine 120 when the vehicle starts moving again; thus, imitating the clean and quiet operation of a heavy duty electric powered vehicle (e.g., trolley bus).

At step 310, a determination is made as to whether the necessary conditions for turning off the engine 120 and keeping it turned off are met. First, because Stop-Start operation is not technically necessary to operate the vehicle, at step 320, a determination is made as to whether the Stop-Start or Idle-Stop function is enabled. Second, because the states of charge (SOC's) of the vehicle energy storage systems 130, 140 must be above minimum operating thresholds to sustain the accessory power requirements during a vehicle Stop-Start or Idle-Stop cycle, at steps 330, 340, a determination is made as to whether the states of charge (SOC's) of the vehicle energy storage systems 130, 140 must be above minimum operating thresholds to sustain the accessory power requirements during a vehicle Stop-Start or Idle-Stop cycle. The vehicle must be in a condition where it will not immediately need the traction power supplied by the engine 120 or engine/generator during the time required for at least one complete Stop-Start cycle. Thus, at step 350, a determination is made as to whether the vehicle speed is below a minimum stop engine threshold that would indicate that the vehicle is coming to a stop. In one or more additional embodiments, the method 300 may use time history information and route sensitive information from a vehicle location, and a route identification system that would allow the engine 120 to be turned off in noise-sensitive areas and during downhill travel when the engine 120 is not required.

During downhill travel in a standard drive system vehicle the engine 120 may use a “Jake” cylinder compression brake, the transmission may use a hydraulic compression “retarder”, or an engine-transmission combination of a Jake brake and retarder may provide deceleration assistance. Because of this deceleration assistance and the PTO's for the control accessories, the engine 120 is not turned off when traveling downhill. In a hybrid-electric vehicle (HEV) with electrically driven accessories 110 the engine 120 can be turned off because the deceleration assistance is provided by the braking regeneration drag of the electric propulsion motor on the drive train and the braking regeneration may provide enough power to run all the electrically driven accessories. When the high voltage electric energy storage 130 is full, braking regeneration power can be dissipated by braking resistors and by using the generator 150 to spin the engine 120 against its own compression and PTO loads. Thus, while the engine is spinning by means of the generator and not consuming fuel, the engine may power any PTO accessories such as a low voltage alternator, oil pump, and coolant pump. Additionally, as an alternative to separate electric accessories 110 or hydraulic accessories, the accessories could be left as engine PTO loads that continue to run when the engine fuel is cut off, powered from the generator 150 and high voltage energy storage 130.

At step 360, the Stop-Start control computer stops the engine 120 by commanding the engine control unit to turn off the injection signals to the fuel injectors. Thus, the engine 120 turns off by stopping the engine fuel supply. If the engine 120 was stopped by either turning off the ignition or stopping the air intake there is a possibility of damaging the engine 120 during turn on because of a build up of unburned fuel in one or more of the engine cylinders. In the Stop-Start method 300, the ignition and air intake are left on.

At step 370, a check is made for any condition that would require an engine restart. First, at steps 380, 390, a determination is made as to whether either of the SOC's of the vehicle high voltage or low voltage energy storage systems 130, 140 drops below minimum restart thresholds. If so, the engine 120 must restart. The restart thresholds are significantly below the operating thresholds so as to prevent an oscillation of the Stop-Start cycles. Second, if the vehicle needs more start-up traction power than can be provided by the stored high voltage energy 130 the engine 120 must restart to supply that power. At step 400, a determination is made as to whether the vehicle speed is above a minimum “start engine” threshold that would indicate that the vehicle is starting into launch acceleration. The “start engine” vehicle speed threshold is set far enough above the “stop engine” vehicle speed threshold to prevent Stop-Start cycle oscillation during normal operation of the vehicle. In one or more additional embodiments, the method 300 may use time history information and route sensitive information from a vehicle location, and a route identification system that would allow the engine to remain off in noise-sensitive areas and during downhill travel when the engine is not required. If any of these conditions 380, 390, 400 are met, at step 410, the engine 120 is turned on and control returns to step 310.

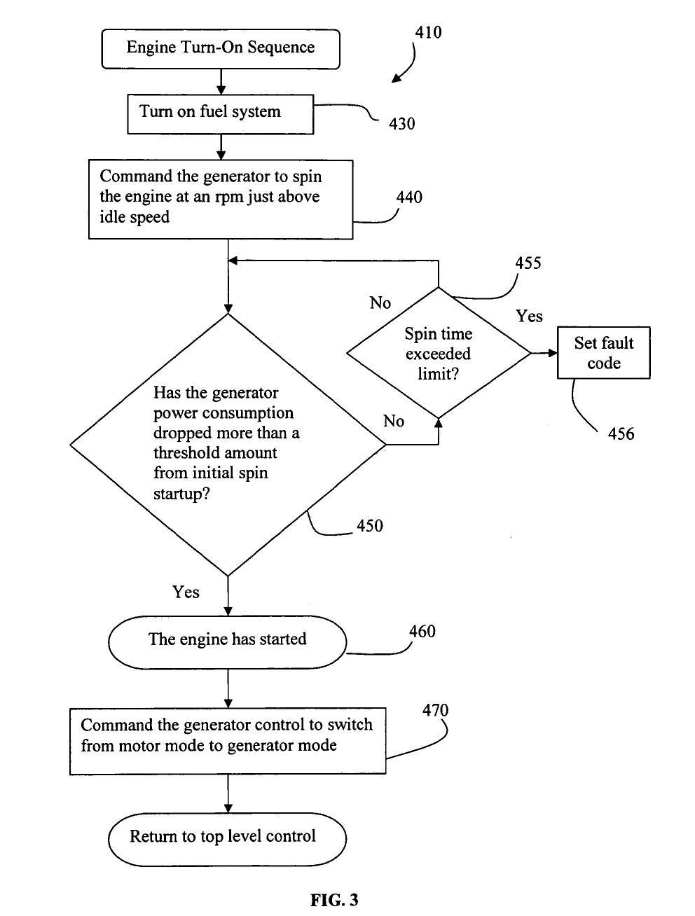

With reference to FIG. 3, the method 410 for turning on the engine 120 (without damaging the engine 120) will now be described. First, at step 430, is to turn on the fuel system by commanding the engine control unit to restore the signals to the fuel injectors.

Second, at step 440, is to spin the engine. In a series hybrid the generator 150 is switched to a motor and draws power from the high voltage system to rotate the engine 120 at an rpm above the engine idle rpm. In a parallel hybrid this function is performed by decoupling the motor 220 from the drive train or by using a separate starter. Some modern engines have a heavy-duty low voltage starter/alternator 240 that may function for this purpose if it is suitable to sustain the hundred of starts that may be required per day.

When the generator spins the engine 120 during startup, the Stop-Start or Idle-Stop control computer, at step 450 monitors the power required by the generator to keep the engine 120 spinning. When the required generator 150 power drops below a cranking power threshold the engine state, at step 460, is defined as running and, at step 470, the Stop-Start or Idle-Stop control computer commands the generator inverter/controller 155 to switch from the motor mode (power negative) back into the generator mode (power positive). At step 455 in a fail-safe control the engine spinning is stopped after a maximum allowed spin time and a fault code is set at step 456.

In one or more embodiments of the systems 100, 200, one or both of the systems 100, 200 may include one or more the following: the software resides in an STW hybrid vehicle controller that uses an SAE J1939 “CAN” control area network to interface to the high voltage and low voltage electric energy storage 130, 140, and other vehicle sensors and actuators; the systems 100, 200 include Siemens “ELFA” electric drive components including the generator 150, DUO-Inverter/controller 155, 156, 157 and electric propulsion motor 159; the speed is determined by reading the electric motor rpm through the motor controller 156; the low voltage SOC is determined from an analog to digital sensor that reads the battery voltage; the high voltage SOC is determined from the energy storage controller 158; the energy storage can be ultracapacitors, batteries, flywheels, or other device that stores and supplies electrical energy; the generator rpm and power level is obtained and controlled through the generator inverter/controller 155; the engine rpm can also be obtained from either the generator controller 155 or the engine electronic control unit; and control of the engine 120 is performed through the CAN interface to the engine control unit.

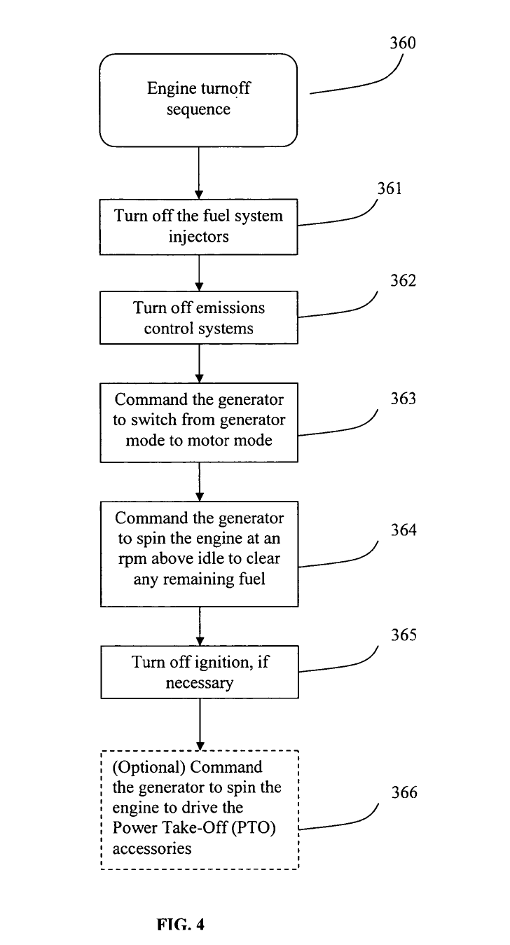

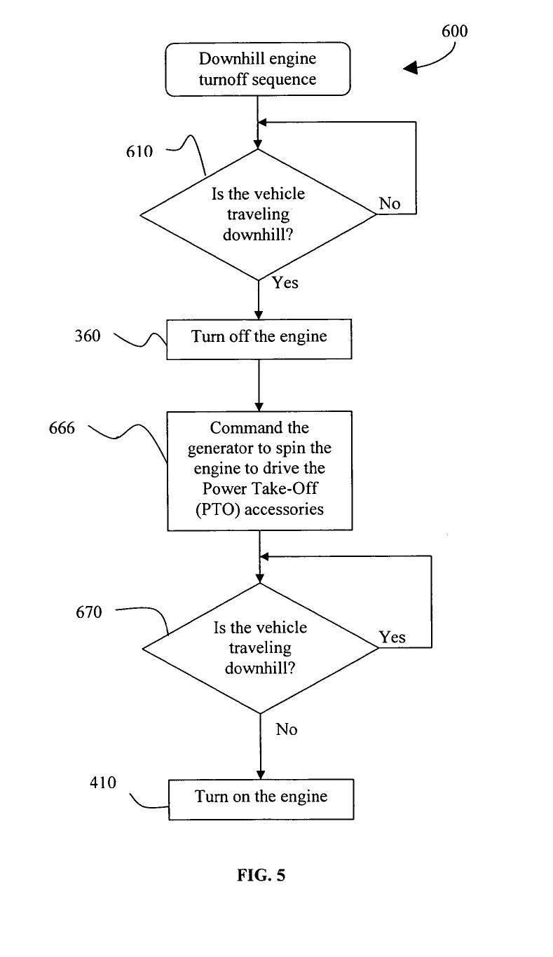

With reference to FIG. 4, an exemplary engine turnoff or shutdown sequence 360 includes, at step 361, turning off the fuel injectors supply of fuel to the engine 120. The fuel pump is not turned off so as to provide the fuel pressure as will be required for engine restart. Typically, to minimize exhaust emissions there may also be some emissions control devices to be shut down like evaporative control and EGR. Thus, at step 362, the emissions control systems are turned off. At step 363, the generator 150 is switched to motor mode to spin the engine 120 to clear any remaining fuel and send the exhaust products to the exhaust after treatment. Thus, at step 364, the generator 150 is commanded to spin the engine 120 at an rpm above idle to clear any remaining fuel. For a spark ignition engine, spark ignition is turned off at step 365, if necessary for engine control operation. Finally, at optional step 366, the generator 150 can be commanded to spin the engine 120 to run any PTO accessory devices 180 without consuming engine fuel. Such an operation is useful for maintaining engine crankshaft rotation at a stop, during stored energy only operation, and for slowing a vehicle during downhill travel as described by the flow diagram sequence in FIG. 5 below. Braking regeneration puts a drag on the vehicle driveline while providing power for the generator 150 to spin the engine 120. The generator 150 works against the engine compression and the load power required by the PTO devices.

With reference to FIG. 5, an exemplary downhill engine turnoff sequence 600 includes, at step 610, first determining if the vehicle is traveling downhill from vehicle location and direction of travel along with topographic information, route, information, and/or vehicle attitude information. If it is determined that the vehicle is traveling downhill, at step 350, the engine 120 is turned off as described by the flow diagram in FIG. 4. Typically, at this point and not shown, the propulsion motor 159 switches from motor mode to generator mode. At step 666, the generator 150 switches to motor mode to spin the engine 120. This operation continues until the vehicle is no longer traveling downhill as determined in step 670. Finally, normal operation is resumed at step 410 where the engine restart sequence is initiated.

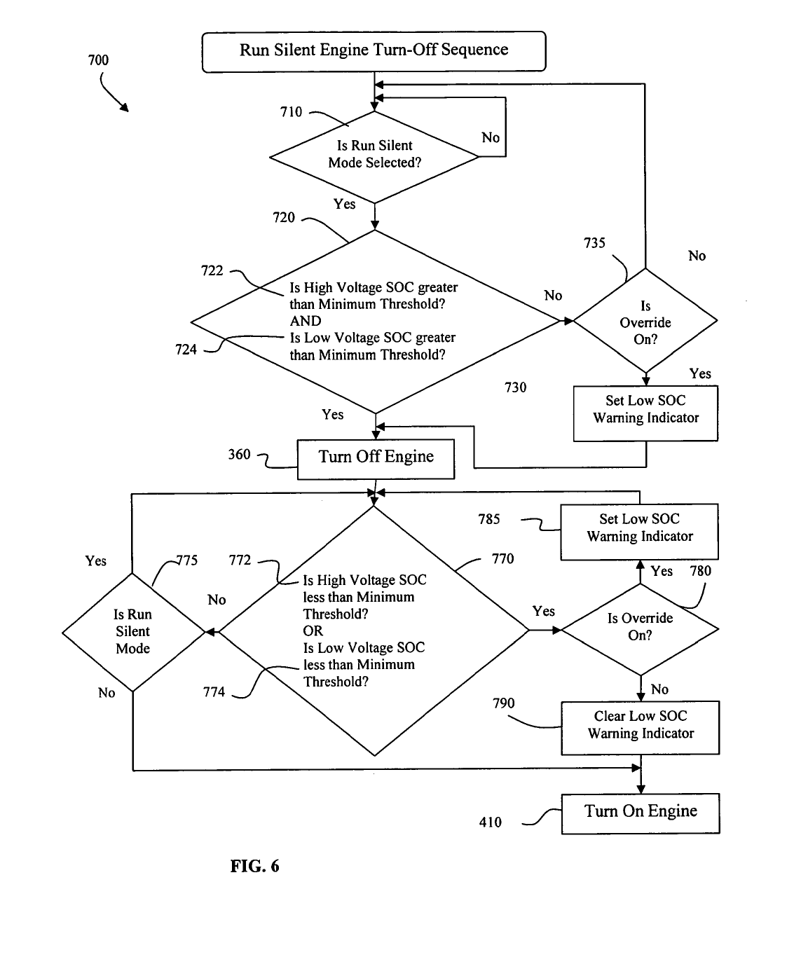

With reference to FIG. 6, an exemplary Run Silent mode engine turnoff sequence 700 includes, at step 710, first determining if the run silent mode has been selected manually or automatically from vehicle location and direction of travel along with topographic information, route, information, and/or vehicle attitude information. If it is determined that the run silent mode has been selected, at step 720, a determination is made that the states of charge (SOC's), step 722 and step 724, of the high and low voltage vehicle energy storage systems 130, 140 are above minimum operating thresholds to sustain the accessory power requirements if the engine is turned off. If the SOC's are above the minimum operating thresholds, at step 360 the engine 120 is turned off as described by the flow diagram in FIG. 4. If the SOC's are below the minimum operating thresholds, at step 730 a low SOC warning indicator is set and at step 735 a determination is made if an override is set. If the override is not on the control passes back to the start at step 710. If the override is on for testing, maintenance, or emergency purposes, control passes to step 360 where the engine 120 is turned off as described by the flow diagram in FIG. 4. The engine turn off sequence at step 360 includes the optional step of continuing to spin the engine 120 to drive the PTO accessories 180 with the fuel cut off.

At step 770, a check is made for any condition that would require an engine restart. First, at steps 772, 774, a determination is made as to whether either of the SOC's of the vehicle high voltage or low voltage energy storage systems 130, 140 drops below minimum restart thresholds. The restart thresholds are significantly below the operating thresholds so as to prevent an oscillation of the Stop-Start cycles. If the SOC's are above the thresholds a determination is made at step 775 as to whether the Run Silent mode is still selected. If the Run Silent mode is still selected control passes back to step 770. If the Run Silent mode has been cancelled the control passes to restart the engine at step 410.

Returning to step 770, if the SOC's are below the minimum thresholds, a determination is made at step 780 as to whether the override is selected. If the override is on, the low SOC warning indicator is set at step 785 and control is passed back to step 770. At step 780, if the override is off the low SOC warning indicator is cleared at step 790 and finally, normal operation is resumed at step 410 where the engine restart sequence is initiated.

In one or more additional embodiments, the method 700 may use time history information and route sensitive information from a vehicle location, and a route identification system that would allow the engine to remain off in noise-sensitive areas and during downhill travel when the engine is not required.

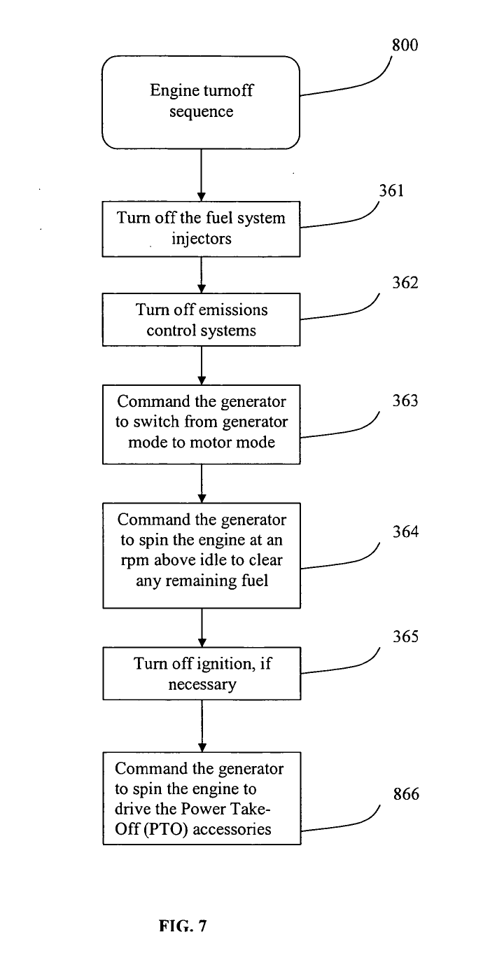

With reference to FIG. 7, an exemplary engine turnoff or shutdown sequence 800 never stops engine crankshaft rotation and includes, at step 361, turning off the fuel injectors supply of fuel to the engine 120. The fuel pump is not turned off so as to provide the fuel pressure as will be required for engine restart. Typically, to minimize exhaust emissions there may also be some emissions control devices to be shut down like evaporative control and EGR. Thus, at step 362, the emissions control systems are turned off. At step 363, the generator 150 is switched to motor mode to spin the engine 120 to clear any remaining fuel and send the exhaust products to the exhaust after treatment. Thus, at step 364, the generator 150 is commanded to spin the engine 120 at an rpm above idle to clear any remaining fuel. For a spark ignition engine, spark ignition is turned off at step 365, if necessary for engine control operation. Finally, at step 866, the generator 150 is commanded to spin the engine 120 to run any PTO accessory devices 180 without consuming engine fuel. Such an operation is useful for maintaining engine crankshaft rotation at a stop, during stored energy only operation, and for slowing a vehicle during downhill travel as described by the flow diagram sequence in FIG. 5. Braking regeneration puts a drag on the vehicle driveline while providing power for the generator 150 to spin the engine 120. The generator 150 works against the engine compression and the load power required by the PTO devices.

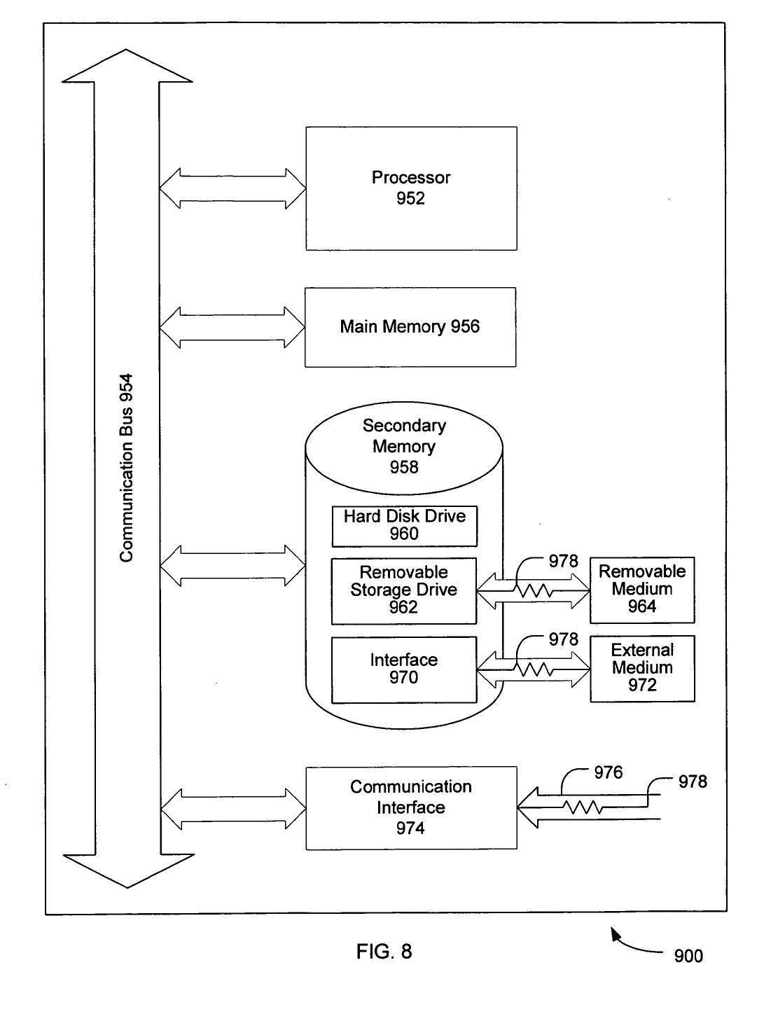

FIG. 8 is a block diagram illustrating an exemplary computer 900 as may be used in connection with the systems 100, 200 to carry out the above-described methods 300, 410, 360, 366, 600; below described functions 700, 800; and other functions. For example, but not by way of limitation, the computer 900 may be a digital control computer that has the physical and protocol interfaces with the vehicle control and various component computers that control and report subsystem status. However, other computers and/or architectures may be used, as will be clear to those skilled in the art.

The computer 900 preferably includes one or more processors, such as processor 952. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 952.

The processor 952 is preferably connected to a communication bus 954. The communication bus 954 may include a data channel for facilitating information transfer between storage and other peripheral components of the computer 900. The communication bus 954 further may provide a set of signals used for communication with the processor 952, including a data bus, address bus, and control bus (not shown). The communication bus 954 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer 900 preferably includes a main memory 956 and may also include a secondary memory 958. The main memory 956 provides storage of instructions and data for programs executing on the processor 952. The main memory 956 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 958 may optionally include a hard disk drive 960 and/or a removable storage drive 962, for example a floppy disk drive, a magnetic tape drive, a compact disc (“CD”) drive, a digital versatile disc (“DVD”) drive, a flash memory drive stick, etc. The removable storage drive 962 reads from and/or writes to a removable storage medium or removable memory device 964 in a well-known manner. Removable storage medium 964 may be, for example, a floppy disk, magnetic tape, CD, DVD, flash memory drive stick, etc.

The removable storage medium 964 is preferably a computer readable medium having stored thereon computer executable code (i.e., software) and/or data. The computer software or data stored on the removable storage medium 964 is read into the computer 900 as electrical communication signals 978.

In alternative embodiments, secondary memory 958 may include other similar means for allowing computer programs or other data or instructions to be loaded into the computer 900. Such means may include, for example, an external storage medium 972 and an interface 970. Examples of external storage medium 972 may include an external hard disk drive or an external optical drive, external semiconductor memory, or an external magneto-optical drive.

Other examples of secondary memory 958 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 972 and interfaces 970, which allow software and data to be transferred from the removable storage unit 972 to the computer 900.

Computer 900 may also include a communication interface 974. The communication interface 974 allows software and data to be transferred between computer 900 and external devices (e.g. printers), networks, or information sources. For example, computer software or executable code may be transferred to computer 900 from a network server via communication interface 974. Examples of communication interface 974 include a modem, a network interface card (“NIC”), a communications port, a PCMCIA slot and card, an infrared interface, and an IEEE 1394 fire-wire, just to name a few.

Communication interface 974 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/internet protocol (“TCP/IP”), serial line internet protocol/point to point protocol (“SLIP/PPP”), and so on, but may also implement customized or non-standard interface protocols as well.

Software and data transferred via communication interface 974 are generally in the form of electrical communication signals 978. These signals 978 are preferably provided to communication interface 974 via a communication channel 976. Communication channel 976 carries signals 978 and can be implemented using a variety of communication means including wire or cable, fiber optics, conventional phone line, cellular phone link, radio frequency (RF) link, or infrared link, just to name a few.

Computer executable code (i.e., computer programs or software) is stored in the main memory 956 and/or the secondary memory 958. Computer programs can also be received via communication interface 974 and stored in the main memory 956 and/or the secondary memory 958. Such computer programs, when executed, enable the computer 900 to perform the various functions of the present invention as previously described.

In this description, the term “computer readable medium” is used to refer to any media used to provide computer executable code (e.g., software and computer programs) to the computer 900. Examples of these media include main memory 956, secondary memory 958 (including hard disk drive 960, removable storage medium 964, and external storage medium 972), and any peripheral device communicatively coupled with communication interface 974 (including a network information server or other network device). These computer readable mediums are means for providing executable code, programming instructions, and software to the computer 900.

In an embodiment that is implemented using software, the software may be stored on a computer readable medium and loaded into computer 900 by way of removable storage drive 962, interface 970, or communication interface 974. In such an embodiment, the software is loaded into the computer 900 in the form of electrical communication signals 978. The software, when executed by the processor 952, preferably causes the processor 952 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

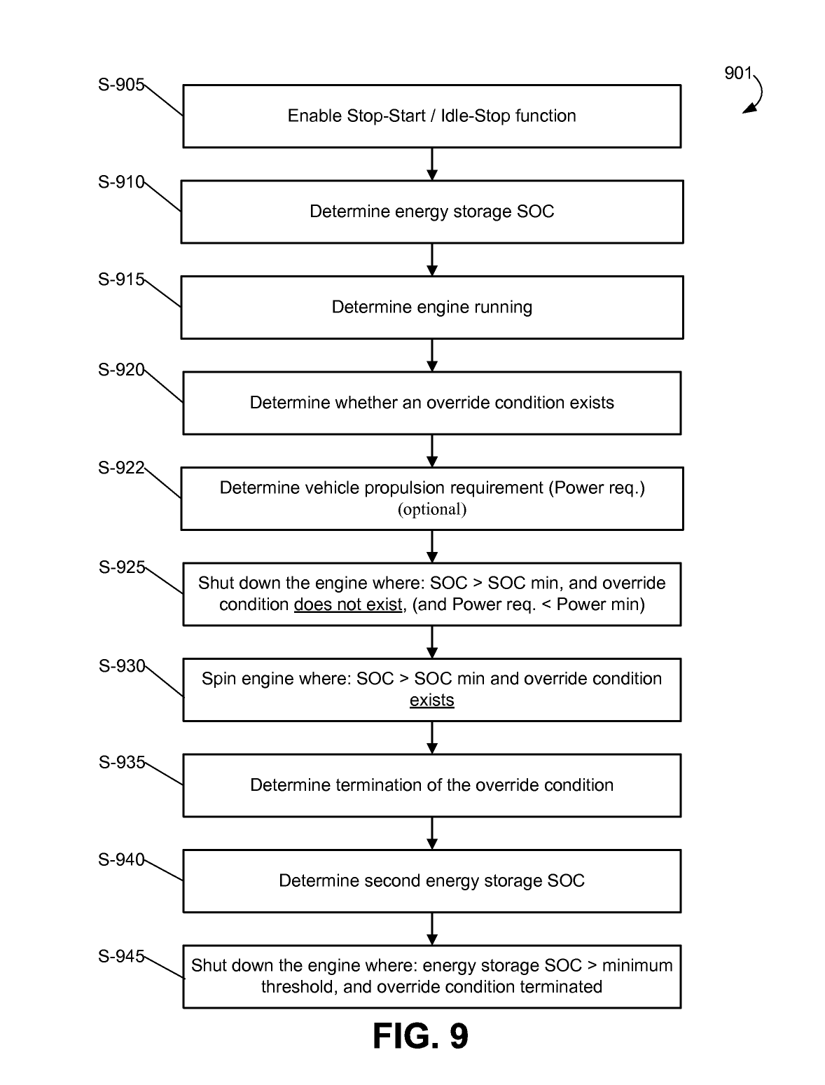

FIG. 9 is a flow chart of an exemplary engine turnoff sequence that is inhibited upon predetermined override conditions. In particular the Inventor has discovered that while Stop-Start and an Idle-Stop algorithms provide certain benefits, for example, improving fuel efficiency, reducing noise, reducing emissions, etc., under certain circumstances, this same functionality may be temporarily undesirable. For example, where a vehicle is being maintained, it may be desirable to inhibit that vehicle's Stop-Start/Idle-Stop from operating, as it may result in an engine appearing to be turned off but starting back up unexpectedly upon the occurrence of a threshold event (e.g., propulsion energy storage SOC dropping below a minimum threshold). Similarly, it may be desirable to inhibit the Stop-Start/Idle-Stop from shutting down the engine during periods where engine heat is demanded, such as when the engine is operating in a cold environment or when cabin heat is drawn from the engine. These examples are understood to be exemplary, as other circumstances are contemplated where ancillary benefits of running the engine (e.g., creating vibration, noise, heat, PTO, etc.) outweigh the direct benefits of shutting the engine down.

Accordingly, in a HEV configured to operate a Stop-Start and/or an Idle-Stop algorithm, all or part of the turnoff sequence previously described may be modified to include additional protections or criteria. In particular, method for controlling a hybrid-electric vehicle 901 begins with step (S-905) enabling a function comprising at least one of a Stop-Start and an Idle-Stop function (“Idle-Stop”). Enabling the Idle-Stop, may be result from a driver, or other person, selecting a switch or other device. Equally, the Idle-Stop may be fully automatic and programmed into the vehicle control software.

Next, the method 901 includes a set of determinations or measurements. In particular, at step (S-910) the propulsion energy storage State Of Charge (SOC) is determined, at step (S-915) it is determined whether the engine is running, and at step (S-920) an override condition is checked. While, the various determination steps are organized as illustrated, it is understood that they are not limited to the particular order shown, but may be made in a different order and/or combined.

Moreover, the method 901 may include additional and/or supplemental determinations without detracting from minimum listed determinations (or their functional equivalents). For example, it may be desirable to include an additional determination into a vehicle propulsion power requirement at step (S-922). This determination may be similar to the determination described earlier, that the vehicle be in a condition where it will not immediately need the traction power supplied by the engine during the time required for at least one complete Idle-Stop cycle (“propulsion power requirement” determination). Also for example, method 901 may include secondary determinations such as whether the most recent SOC reading is sufficiently close in time to be considered accurate or whether an additional SOC reading may be required. Additionally, some or all of the listed determinations may be performed actively, such as by using direct hardware or software comparisons, or they may be performed passively/inherently, such as by predicating a remaining sequence of steps on a prior step (e.g., only engage the method 901 when the engine is running).

Once the appropriate determinations are made, at step (S-925) the engine is shut down if the required shut down conditions are met. In particular, the engine may shut down where energy storage SOC is above an energy storage State Of Charge minimum threshold and the override condition does not exist. In other words, the Idle-Stop will be engaged or un-inhibited. Preferably, shutting down the engine will include the steps described above for engine shutdown as well as precluding the generator from spinning the engine. It is understood that this control functionality may be incorporated directly into the Idle-Stop controls in the first instance, such that the Idle-Stop thresholds include the override thresholds determined above. In addition, this step may incorporate additional determinations and required considerations, such as a propulsion power requirement being less than a propulsion power minimum threshold or an electric accessory power requirement being less than an electric accessory power minimum threshold, for example.

Likewise, once the appropriate determinations are made, at step (S-930) the engine is spun if the required spin conditions are met. In particular, the engine spins where energy storage SOC is above an energy storage State Of Charge minimum threshold (and any other conditions that would normally trigger an Idle-Stop) but the override condition does exist. In other words, the Idle-Stop will be disengaged or inhibited. As above, it is understood that this functionality may be incorporated directly into the Idle-Stop controls in the first instance, such that the Idle-Stop thresholds include the thresholds determined above. In addition, it is understood that the override conditions may be incorporated as part of the Idle-Stop trigger conditions in the first instance.

In “spinning” the engine, combustion (and compression) may or may not be present. In particular, the engine spin conditions/criteria may determine both the question whether the engine is to be spun and how it is to be spun (i.e., with/without combustion, with/without compression, etc.). For example where the override condition is associated with vehicle maintenance and a need to identify the engine as being on but subject to an active Idle-Stop, the engine need only indicate to a mechanic that it is on. This may be done by either running the engine (i.e., with combustion) or operating the generator to spin the engine without combustion. Also for example, where the override condition is associated with a heat demand, the engine should be operated with combustion so as to generate heat. Also for example, where the override condition is associated a braking need (e.g., during travel down long downgrades) the engine may be spun without combustion but with compression (“engine lifting” or “motoring the engine”). Also, in other embodiments, the engine may continue to spin without combustion, so as to operate one or more PTO devices, such as described earlier.

Next, at step (S-935), method 901 may include an additional determination that the override condition has terminated, similar to the initial determination of the override condition at step (S-920). Likewise, upon determining the termination of the override condition (S-935), method may determine a second energy storage SOC (S-940) similar to the initial determination of the SOC at step (S-910). Finally, at step (S-945), where the energy storage SOC is at or above the SOC threshold and the override condition has been terminated, the engine may be shut down.

Returning to stem (S-920), the override condition of step (S-920) represents a condition where it is desirable to sustain engine operation despite the ability to operate the HEV off stored power. Preferably, override condition is automatic (i.e., not requiring driver action), and includes at least one of a maintenance status and/or a temperature demand. However, the override condition may also be a direct manual selection, or may represent an emergency condition as described earlier. Also, the timing of the override determination step may vary and even reoccur. For example, according to one embodiment, the override determination may be made after the Idle-Stop has already shut down the engine, and may trigger the engine to restart before the Idle-Stop restart conditions are met.

According to one preferable embodiment, method 901 is directed toward preventing the engine from being shutdown during maintenance (or remaining shutdown as part of an earlier Idle-Stop upon the start of maintenance). Besides a relying on a direct, manual override, method 901 may advantageously infer a vehicle maintenance status by using various sensors and signals on the vehicle. For example, most vehicles will include some form of removable or accessible port for maintenance, many of which are instrumented to indicate an unsecured condition. Likewise, many vehicles will have an entire engine access door, which is often configured to provide an indication of when it is open. In some cases, the indication may be incorporated with a port/door illumination device, for example. In cases such as these, the method 901 may include determining an override condition based on a maintenance status, where the maintenance status includes at least one of an indication of an unsecured maintenance port and an open engine door. Alternate indications of a maintenance status are also contemplated. For example a maintenance status indication may include an active communications coupling with a off board diagnostic device, a weight off wheels indication, a door open time out, etc.

According to one preferable embodiment, method 901 is directed toward preventing the engine from being shutdown while there is a temperature/heat demand (or remaining shutdown as part of an earlier Idle-Stop upon receiving the temperature demand). Similar to the above, besides a relying on a direct, manual override, method 901 may advantageously infer a vehicle temperature demand by using various sensors and signals on the vehicle. For example, most vehicles will include some form of coolant temperature sensor, many of which are instrumented to indicate a low temperature condition. The same applies to ambient temperature, where many vehicles have an external thermometer. Likewise, many vehicles will have an internal environmental heater (e.g., cabin heat), which is often configured to provide an indication of when it is on, or heat is required. In some cases, the indication may be incorporated with a “heater on” indication device.

Where a heat/temperature demand is indicated, determined, or otherwise available, the method 901 may then include determining an override condition based on the temperature demand. In particular, the override condition may be associated with an engine temperature below an engine temperature minimum threshold or an environmental heating demand in excess of an engine heat supply capacity. In the case of a demand vs. supply comparison, said comparison may be performed in an onboard control computer as part of the Idle-Stop algorithm. Alternate indications of a temperature-based override condition are also contemplated. For example, a temperature demand may be indicated by an outside temperature being below a predetermined value, by a blower request for an external heating supply, etc. Also, a temperature demand may be indicated by an advance warning (e.g., via GPS) of oncoming extended forced engine-off conditions (e.g., approaching an enclosed structure or noise-free/engine-off zone), followed by a shifting the heat available vs. heat required comparison.

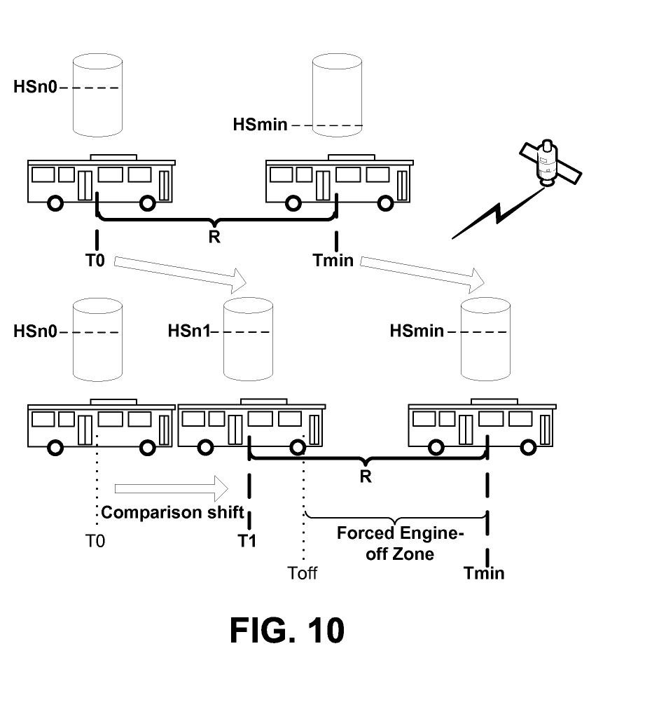

FIG. 10 illustrates this last example of using a heat available vs. heat required comparison shift. In particular, at time (T0) a comparison is made between the “heat supply” (HSn0) available for the HEV (here, a metropolitan transit bus) and a “heat demand” (not shown). The comparison may take place whenever an Idle-Stop is desired. Here, heat supply HSn0 is illustrated as a cylinder being filled up to a dashed-line quantity. While thermal batteries are one option, resulting in a direct heat supply measurement, a heat supply quantity will typically be determined by other properties such as coolant temperature of the engine (or other cooling system). The heat supply determination may be augmented by anticipating a heat creation event. For example an anticipated braking resistor usage may be factored in as part of the heat supply.

Completing the calculation, at Tmin, the available heat supply will be at or below a minimum threshold (HSmin). In particular, the heat supply will be exhausted at Tmin. Preferably, an approximate range (R) will be determined (ending at Tmin) where the heat demand can be supplied without running the engine, and the engine may be shut off during this period. According to this embodiment, a further determination may then be made (e.g., using GPS), that the HEV is approaching a “forced engine-off zone” (beginning at Toff), and wherein shutting off the engine at T0 would then result the HEV reaching HSmin (Tmin) while within the forced engine-off zone. Thus, the HEV would be unable to re-start the engine. In this scenario, the comparison may be initially made at T0 to determine a preliminary engine-off range (R), which can later be used shift the comparison and/or the engine-off period to address the forced engine-off zone. Accordingly, the Idle-Stop may be inhibited from time T0 until time T1, mitigating the impact of the engine-off zone. Also, the comparison may be redone to include the actual heat capacity (HSn1) at T1. In which case, if the heat supply HSn1 has not decreased as anticipated, or the head demand has decreased, the Idle-Stop may be further postponed or inhibited.

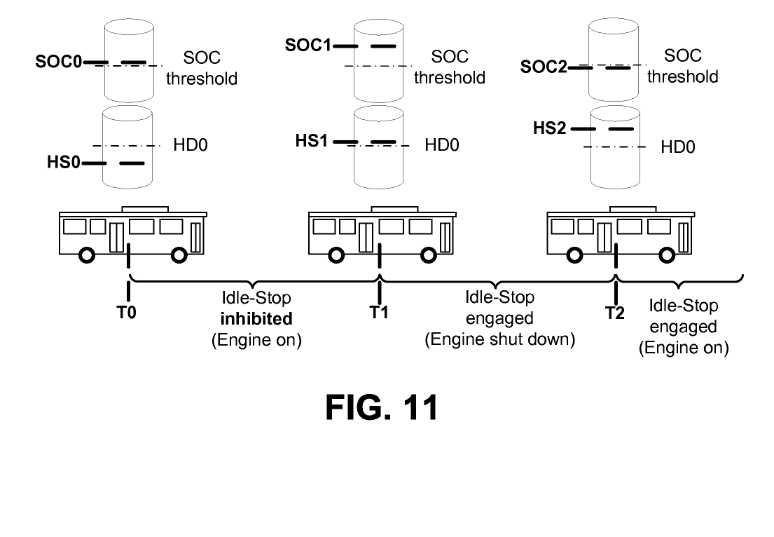

FIG. 11 is a simplified illustration of one embodiment of the method described in FIG. 9. In particular, at time T0, the propulsion energy storage SOC (SOC0) has crossed above the SOC threshold, prompting an Idle-Stop function. However, an override condition based on temperature exists. In particular, the HEV has a heat supply (HS0) that is less than an actual heat demand (HD0). Thus, the Idle-Stop will be inhibited, and the engine will remain on until time T1.

At time T1, the propulsion energy storage SOC (SOC1) has actually increased further above the SOC threshold (e.g., due to extended engine genset operation), still prompting an Idle-Stop function. However, an override condition based on temperature has terminated and no longer exists. In particular, the HEV has a heat supply (HS1) that is less than an actual heat demand (HD1). Thus, the Idle-Stop will be engaged, and the engine will shut down until time T2.

At time T2, the override condition based on temperature still does not exist. In particular, the HEV has a heat supply (HS2) that has actually increased further above an actual heat demand (HD2) (e.g., due to a regenerative braking event). Thus, the Idle-Stop will remain engaged. However, since the propulsion energy storage SOC (SOC2) has fallen below the SOC threshold (e.g., due to operating the HEV on stored energy for an extended period), the engine will be commanded on as part of the normal Idle-Stop sequence to recharge the HEV's propulsion energy storage. It is understood that numerous other variations of the method may take place as different override conditions make be used and/or different vehicle states may be present. It is further understood that the FIG. 11 is not intended to be limiting, but rather to pictorially illustrate one embodiment of the method described above.

While embodiments and implementations of the invention have been shown and described, it should be apparent that many more embodiments and implementations are within the scope of the invention. Accordingly, the invention is not to be restricted, except in the light of the claims and their equivalents.

What is claimed is:

1. A method for controlling a hybrid-electric vehicle, the hybrid-electric vehicle having an engine, a generator, an energy storage, and a control computer, the method comprising:
enabling a function comprising at least one of a Stop-Start and an Idle-Stop function;
determining an energy storage first State Of Charge;
determining that an engine is running;
determining whether an override condition exists, the override condition including a maintenance status;
shutting down the engine if the energy storage first State Of Charge is above an energy storage State Of Charge minimum threshold and the override condition does not exist; and,
spinning the engine if the energy storage first State Of Charge is above the energy storage first State Of Charge minimum threshold and the first override condition exists.

2. The method of claim 1, wherein the spinning the engine comprises leaving the engine running.

3. The method of claim 1, wherein the spinning the engine comprises shutting down the engine and commanding the generator to spin the engine.

4. The method of claim 1, wherein the maintenance status comprises an indication of at least one of an unsecured maintenance port and an open engine door.

5. The method of claim 1, further comprising:
determining a termination of the override condition;
determining an energy storage second State Of Charge; and,
shutting down the engine if the energy storage second State Of Charge is above the energy storage State Of Charge minimum threshold and the termination of the override condition has been determined.

6. The method of claim 5, wherein the termination of the override condition comprises receiving an indication of at least one of the maintenance port being secured and the engine door being closed.

7. The method of claim 5, further comprising commanding the generator to spin the engine to drive at least one Power Take-Off accessory in response to the shutting down the engine.

8. The method of claim 1, further comprising determining a vehicle propulsion power requirement; and,
wherein the shutting down the engine is restricted to the first vehicle propulsion requirement also being below a vehicle propulsion minimum threshold.

9. A method for controlling a hybrid-electric vehicle, the hybrid-electric vehicle having an engine, a generator, an energy storage, and a control computer, the method comprising:
enabling a function comprising at least one of a Stop-Start and an Idle-Stop function;
determining an energy storage first State Of Charge;
determining that an engine is running;
determining whether an override condition exists, the override condition including a heat demand;
shutting down the engine if the energy storage first State Of Charge is above an energy storage State Of Charge minimum threshold and the override condition does not exist; and,
spinning the engine if the energy storage first State Of Charge is above the energy storage first State Of Charge minimum threshold and the first override condition exists.

10. The method of claim 9, wherein the spinning the engine comprises leaving the engine running.

11. The method of claim 9, wherein the spinning the engine comprises shutting down the engine and commanding the generator to spin the engine.

12. The method of claim 9, wherein the heat demand comprises an indication of at least one of an engine temperature below an engine temperature minimum threshold and an environmental heating demand in excess of an engine heat supply capacity.

13. The method of claim 9, further comprising:
determining a termination of the override condition;
determining an energy storage second State Of Charge; and,
shutting down the engine if the energy storage second State Of Charge is above the energy storage State Of Charge minimum threshold and the termination of the override condition has been determined.

14. The method of claim 13, wherein the termination of the override condition comprises receiving at least one of the termination of the heat demand, an indication of the engine temperature being at or above the engine temperature minimum threshold, and an indication of the environmental heating demand being within the engine heat supply capacity.

15. The method of claim 13, further comprising commanding the generator to spin the engine to drive at least one Power Take-Off accessory in response to the shutting down the engine.

16. The method of claim 9, further comprising determining a vehicle propulsion power requirement; and,
wherein the shutting down the engine is restricted to the first vehicle propulsion requirement being below a vehicle propulsion minimum threshold.

17. A method for controlling a hybrid-electric vehicle, the hybrid-electric vehicle having an engine, a generator, an energy storage, and a control computer, the method comprising:
enabling a function comprising at least one of a Stop-Start and an Idle-Stop function;
determining an energy storage first State Of Charge;
determining that an engine is running;
determining whether an override condition exists, the override condition including a braking need;
shutting down the engine if the energy storage first State Of Charge is above an energy storage State Of Charge minimum threshold and the override condition does not exist; and,
spinning the engine if the first override condition exists.

18. The method of claim 17, wherein the spinning the engine comprises motoring the engine.

19. The method of claim 18, wherein the spinning the engine comprises commanding the generator to motor the engine.
